(19) United States
(12) Patent Application Publication
(10) Pub. No.: US 2023/0234425 A1
(43) Pub. Date: Jul. 27, 2023

(54) AIR FLAP DEVICE

(71) Applicant: Röchling Automotive SE & Co. KG, Mannheim (DE)

(72) Inventor: Jürgen Schneider, Worms (DE)

(21) Appl. No.: 18/099,492

(22) Filed: Jan. 20, 2023

(30) Foreign Application Priority Data
Jan. 24, 2022 (DE) 10 2022 101 560.2

(51) Int. Cl. B60H 1/34

(52) U.S. Cl. CPC B60H 1/3421

(57) ABSTRACT

An air flap device having:
an air flap carrier with an air passage opening through which air can flow,
a plurality of air flaps,
wherein each of these air flaps protrudes at least into the air passage opening and is received on the air flap carrier for operative movement,
wherein each of these air flaps is movable between a first and a second operating position assigned thereto, wherein, for each of these air flaps a covering of the air passage opening by this air flap is greater in the second operating position assigned thereto than in the first operating position assigned thereto,
wherein the plurality of air flaps includes at least one sensing air flap,
a coupling device, wherein the coupling device couples the at least one sensing air flap to at least one other air flap of the plurality of air flaps for joint movement, and
a blocking component assigned to the at least one sensing air flap,
   wherein the blocking component is displaceable between a release position in which it permits movement of the coupling device and a blocking position in which it blocks movement of the coupling device, wherein the coupling device can be moved independently of the blocking component when the blocking member is in its release position.

This Application claims priority in German Patent Application DE 10 2022 101 560.2 filed on Jan. 24, 2022, which is incorporated by reference herein.

The present invention relates to an air flap device, comprising:
an air flap carrier with an air passage opening through which air can flow,
a plurality of air flaps, wherein each of these air flaps protrudes at least into the air passage opening and is operationally movably received on the air flap carrier, wherein each of these air flaps is movable between a first and a second operating position assigned thereto, wherein, for each of these air flaps in the second operating position assigned thereto, a covering of the air passage opening by this air flap is respectively greater than in the first operating position assigned thereto, wherein the plurality of air flaps comprises at least one sensing air flap,
a coupling device, wherein the coupling device couples the at least one sensing air flap to at least one other air flap of the plurality of air flaps for joint movement, and
a blocking component assigned to the at least one sensing air flap, wherein the blocking component is displaceable between a release position in which it allows movement of the coupling device and a blocking position in which it blocks movement of the coupling device.

### BACKGROUND OF THE INVENTION

Such an air flap device is known from the applicant's publication DE 10 2018 131 448 A1.

Air flap devices for motor vehicles are well known in the automotive art. They are primarily used to change the cooling of functional assemblies in the engine compartment by changing the operating position of the air flaps. For each of these air flaps, when in the second operating position assigned thereto (often referred to as the closed position), a cover of the air passage opening by said air flap is greater than in the first operating position assigned thereto (often referred to as the open position). When all air flaps are in their second operating position, the air passage opening is preferably substantially closed for any air flow through it, and when all air flaps are in their first operating position, air can flow through with as little flow resistance as possible. This applies not only to the prior art, but also to the air flap device according to the present invention.

The operation of an air flap device designed as described above has an effect on the pollutant emissions of the motor vehicle due to the cooling of functional assemblies, such as a coolant heat exchanger and thus indirectly the internal combustion engine. Therefore, it is important to be able to check the air flap device at any time for the presence of a malfunction. In practice, such a function check with reasonable effort is more difficult than it may appear at first glance, because it is complicated and expensive to provide the air flap device with a plurality of sensors that detect the positions of all air flaps. This problem is exacerbated by the fact that a function check of the drive of the air flap device is often not sufficient to make a statement about the functionality of the air flap device, because the drive of the air flap device can function without any problems, even though air flaps were damaged or even knocked out of the air flap device by external influences. In particular, it is important that after detection of a malfunction, the air flap device can let the amount of air pass that is sufficient for cooling functional assemblies to prevent the functional assemblies from overheating.

The air flap device of DE 10 2018 131 448 A1 allows using a blocking component and a coupling device as mechanical means to check the functionality of the air flap device and ensures that the air flaps are arranged in an open position. However, the arrangement of these mechanical means leads to an increased space requirement for the air flap device of DE 10 2018 131 448 A1.

### SUMMARY OF THE INVENTION

It is therefore the object of the present invention to provide an air flap device which is of compact design and makes it possible to detect a malfunction of the air flap device.

This object is achieved according to the invention by an air flap device of the type mentioned at the outset, the coupling device of which can be moved independently of the blocking component when the blocking component is in its release position.

An air flap may operatively be movably received on the air flap carrier by movably retaining a portion of the air flap in a receptacle located on the air flap carrier. Accordingly, a malfunction can be detected when another section or no section of the air flap is movably held in the receptacle.

A blockage in the movement of the coupling device is an indication of the detection of a malfunction of the air flap device. In an operational state of the air flap device, when no malfunction is detected such that the blocking component is in its release position, the coupling device can be moved independently of the blocking component, such that no space has to be kept free to allow movement of the blocking component together with the coupling device when the other air flap moves between its first and its second operating positions. Accordingly, this space can be saved in the construction of the air flap device. In particular, this saves space in a direction of movement of the coupling device. A coupling device moves in particular independently of the blocking component when a movement of the coupling device, in particular relative to the air flap carrier, is not necessarily accompanied by a movement of the blocking component, in particular relative to the air flap carrier.

The coupling device couples in particular the at least one sensing air flap with the at least one other air flap, preferably with the plurality of air flaps that are different from the sensing air flap, particularly preferably with substantially all air flaps or all the air flaps that are different from the sensing air flap, of the plurality of air flaps for joint movement. This coupling is preferably such that all of the air flaps coupled by the coupling device of the plurality of air flaps assume their respective first operating positions substantially simultaneously and assume their second operating positions substantially simultaneously.

The air flap device according to the invention has proven to be particularly stable in crash tests.

To prevent undesired erroneous detection of a malfunction of the air flap device, the air flap device comprises a retaining formation coupled to the sensing air flap, wherein, when the sensing air flap is received on the air flap carrier for operative movement, the retaining formation holds the blocking component in its release position.

A transition of the blocking component from its release position to its blocking position, and thus a detection of a malfunction of the air flap device, can be achieved particularly reliably if the blocking component is preloaded into the blocking position by a pretensioning arrangement, which is in particular designed as a spring, preferably a bending spring.

The blocking component preferably rests against the retaining formation. To reduce a friction or/and the likelihood of the blocking component and the retaining formation getting caught by contact over a large area, one element made up of the blocking component and the retaining formation has a retaining contact projection and the other element made up of the blocking component and the retaining formation has a mating retaining contact surface which protrudes when these components touch as the blocking component is held in its release position by the retaining formation. The retaining contact projection and the mating retaining contact surface can form a point bearing or a tip bearing, or a linear retaining contact projection and a substantially flat mating retaining contact surface can form a plain bearing in which the contact surface between the retaining contact projection and the mating retaining contact surface is smaller than the mating retaining contact surface, in particular by a factor of 5, 20, 50, or 100. The retaining contact projection can be designed in the form of a preferably pointed rib, a spherical cap, a point or a truncated cone, wherein the shape as a rib allows both a high load-bearing capacity of the contact between the retaining contact projection and the mating retaining contact surface and simple and reliable mold release of the rib bearing this component, e.g. after injection molding.

Malfunctions can be detected in a particularly reliable manner if the sensing air flap is designed in one piece with the retaining formation assigned thereto, wherein the retaining formation preferably forms at least part of a bearing pin of the air detection flap, since the retaining formation then inevitably stops keeping the blocking component in its release position if the sensing air flap is knocked out or removed in some other way.

The air flap arrangement can be made particularly compact by utilizing the space adjacent to a pivot bearing of the sensing air flap, in particular the space present between the pivot bearing of the sensing air flap and a pivot bearing of another air flap from the plurality of air flaps that is adjacent, preferably directly adjacent, to the sensing air flap for the movement of the blocking component when the sensing air flap is held in a receptacle arranged on the air flap carrier on the air flap carrier, such that it can pivot about a sensing air flap pivot axis, and the blocking component can be displaced in a direction substantially parallel to the sensing air flap pivot axis between the release position and the blocked position.

A compact design of the air flap device can be achieved if, during the transition of the other air flap between its first operating position and its second operating position or/and during the transition of the sensing air flap between its first operating position and its second operative position, the coupling device passes along a coupling device movement path which is substantially transverse to a sensing air flap pivot axis of the sensing air flap, preferably wherein the sensing air flap rotates about the sensing air flap pivot axis during the transition between its first operative position and its second operative position, since in this case the coupling device saves space on an eccentric, in particular an eccentric arm, of the other air flap and/or of the sensing air flap.

A locking of the other air flaps, which could lead to possible damage to functional components of a motor vehicle, in their respective second operating positions (closed position) can be prevented in that the coupling device assumes a first coupling position when the other air flap is in its first operating position, in that the coupling device assumes a second coupling position when the other air flap is in its second operating position, in that the coupling device arranged in the first coupling position allows a movement of the blocking component into the blocking position, and in that the coupling device arranged in the second coupling position prevents a movement of the blocking component into the locked position.

This can be implemented in a particularly compact manner in that, during the transition of the blocking component from the release position to the blocking position, at least one section of the blocking component runs through a traverse space section which, when the blocking component is in its release position, is not occupied by the blocking component, such that the coupling device arranged in the first coupling position does not occupy the traverse space section, whereby movement of the blocking component into the blocked position is permitted, and in that a section of the coupling device arranged in the second coupling position occupies the traverse space section, whereby movement of the blocking component into the blocked position is prevented, since the traverse space section experiences a dual use as a passage space both for the coupling device and for the blocking component.

In a particularly simple and stable embodiment, when the coupling device is arranged in its first coupling position, the traverse space section runs through a recess in the coupling device, which recess is preferably surrounded on at least two, particularly preferably on at least three, sides by a material of the coupling device. However, an inner surface of the recess of the coupling device preferably does not surround the recess, such that the recess is not a through opening or/and such that the recess does not have a closed inner circumference surrounding the recess.

The movement of the blocking component into the blocking position can be implemented without space-consuming drive units in that, when the retaining formation no longer holds the blocking component in its release position and the coupling device is arranged in its second coupling position, the blocking component is preferably released due to the action of a force from a pretensioning arrangement of the air flap device, preferably the aforementioned pretensioning arrangement, abuts a section of the coupling device. It is preferred here that, to reduce the probability of snagging during a movement of the coupling device during this contact, both elements of the blocking component and the coupling device have a smooth surface or/and have a flat surface, which abut each other in this contact.

In order to allow electronic motor vehicle on-board systems to detect a malfunction of the air flap device, it is preferred that the air flap device also includes a sensor arrangement which is configured to detect a transition of the blocking component between the release position and the blocking position. The sensor arrangement is configured in particular to be part of an on-board diagnostic system in a motor vehicle.

Since the coupling device can be moved independently of the blocking component, the blocking component can be made more stable and robust, in particular with respect to the dimensional accuracy of the blocking component, while utilizing space that is usually unused. Although a stable design of the blocking component often leads to an increase in volume, since the blocking component is not coupled to the coupling device for joint movement as in DE 10 2018 131 448 A1, no movement space which is larger than the space occupied by the blocking component itself has to be kept free for the blocking component during the movement of the coupling device. Due to its increased dimensional accuracy, the stable embodiment of the blocking component allows reliable detection of the transition of the blocking component between its release position and its blocking position, such that an unexpected positive effect on the reliability of the sensor arrangement results from the fact that when the blocking component is in its release position, the coupling device is movable independently of the blocking component.

The detection of the malfunction of the air flap device can be made particularly safe and reliable in that the sensor arrangement includes a signal path and is configured to detect signals passing through the signal path, and in that the blocking component acts on the signal path in such a way that the signals can pass through the signal path when the blocking component is arranged in one of the release position and the blocking position and the signals cannot pass through the signal path when the blocking component is arranged in the other of the release position and the blocking position.

The check as to whether signals can or cannot pass a signal path can particularly be made more reliable if the signals are electrical signals or/and are optical signals, since such signals can be reliably detected with reliable and simple detectors and the signal paths configured to conduct these signals can be influenced particularly easily, e.g. in that the blocking component interrupts an optical path intended for signal transport in the free space between a light emitter and a light sensor in one of the release position and the blocking position and does not interrupt this optical path in the other of the release position and the blocking position. Likewise, the blocking component can cause light modulation in one of the release position and the blocking position in an optical path intended for signal transport between a light emitter and a light sensor and cause no light modulation or another light modulation there in the other of the release position and the blocking position. Alternatively or additionally, the blocking component can interrupt an electrical circuit configured as a signal path and intended for signal transport in one of the release position and the blocking position and close this electrical circuit in the other of the release position and the blocking position. In the latter case, a section of the blocking component, particularly preferably the entire blocking component, is preferably configured to be conductive, and this section can be made from an electrically conductive plastic, which is preferably an extrinsically conductive plastic, i.e., a plastic which is electrically conductive due to fillers. Conductive particles and/or flakes which can be made of metal and/or carbon, in particular soot, are preferred as electrically conductive fillers.

Both the assembly and the repair of an air flap device proves to be particularly simple if the air flap carrier comprises an air flap carrier frame and a bearing insert which is connected to the air flap carrier frame, wherein each of the air flaps of the plurality of air flaps is received for operative movability, and wherein the bearing insert comprises a guide assembly for the blocking component or/and a guide arrangement for the coupling device, since the bearing insert can be coupled to the air flaps separately from the air flap carrier frame to achieve their operatively movable reception on the air flap carrier. This is particularly made easier if the bearing insert can be separated from the air flap support frame without being destroyed or/and can be operatively connected thereto, in particular repeatably, for example by a non-destructively releasable latching connection.

The components required to detect a malfunction of the air flap device can be protected from environmental influences while maintaining this functionality in that, during the transition of the other air flap between its first operating position and its second operating position or/and during the transition of the sensing air flap between its first operative position and its second operative position, the coupling device passes along a coupling device movement path, in that the bearing insert comprises a bearing insert body formed with a main opening and a bearing insert cover that can be operatively attached to the bearing insert body, wherein the bearing insert cover operatively attached to the bearing insert body closes the main opening in sections and leaves an opening free between the bearing insert cover and the bearing insert body, through which opening at least a section of the coupling device movement path passes. This arrangement permits the movements within the air flap device necessary to carry out a detection of a malfunction, while offering good protection of the elements used from environmental influences. The coupling device is preferably at least partially arranged within the bearing insert body when the coupling device is located in its first or/and second coupling position.

The assembly or repair of the air flap device can be carried out by simply sliding the bearing insert onto the air flaps, without the use of clip connections, if each of the air flaps of the plurality of air flaps is held on a bearing insert axial bearing such that it can be pivoted about a respective air flap pivot axis on the bearing insert, if each of the air flaps of the plurality of air flaps is supported on a coupling device pivotably about a respective coupling pivot axis, wherein each of the air flap pivot axes is oriented substantially parallel to each other air flap pivot axis or/and wherein each of the coupling pivot axes is oriented substantially parallel to each other coupling pivot axis or/and wherein each of the air flap pivot axes is oriented substantially parallel to each coupling pivot axis. Such an air flap device has proven to be particularly stable in pendulum impact tests, since loosening of the clip connections cannot occur.

It is preferable that each air flap of the plurality of air flaps is a sensing air flap, wherein a blocking component or/and a retaining formation or/and a retaining formation or/and a sensor arrangement is assigned to each of which, in each case preferably as a separate component from other components of the same name. For the description and the interaction of these components with their respectively assigned sensing air flap, reference is made to the above explanations in connection with the at least one sensing air flap, which describes the respectively assigned sensing air flaps, provided nothing to the contrary results from the description.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 shows an air flap device according to the invention with all air flaps in the second operating position,

FIG. 2a shows the air flap device according to the invention from FIG. 1 with all air flaps in the first operating position,

FIG. 2b shows the air flap device according to the invention from FIG. 1 with the sensing air flap 16a knocked out and with all remaining air flaps in the first operating position,

FIG. 3 shows a perspective view of a portion of the air flap device from FIG. 1 with all air flaps in the second operating position,

FIG. 4 shows a perspective view of a portion of the air flap device from FIG. 1 with all air flaps in the second operating position and with the bearing insert cover 62 removed,

FIG. 5 shows a perspective view of a portion of the air flap device from FIG. 1 with the sensing air flap 16a knocked out, with all remaining air flaps in the second operating position, and with the bearing insert cover 62 removed,

FIG. 6 shows a perspective view of a portion of the air flap device from FIG. 1 with the sensing air flap 16a knocked out, with all remaining air flaps in an intermediate position between the first and second operating positions, and with the bearing insert cover 62 removed,

FIG. 7 shows a perspective view of a portion of the air flap device from FIG. 1 with the sensing air flap 16a knocked out, with all remaining air flaps in the first operating position, and with the bearing insert cover 62 removed,

FIG. 8 shows a perspective view of a portion of the air flap device from FIG. 1 with the sensing air flap 16a knocked out, with all remaining air flaps in another intermediate position between the first and second operating positions, and with the bearing insert cover 62 removed,

FIG. 9a shows a perspective view of a portion of the air flap device from FIG. 1 with a view of an aspect of a sensor arrangement and the blocking component in the release position,

FIG. 9b shows a perspective view of a portion of the air flap device from FIG. 1 with a view of an aspect of a sensor arrangement from FIG. 9a and the blocking component in the release position,

FIG. 10a shows a perspective view of a portion of the air flap device from FIG. 1 with a view of another aspect of the sensor arrangement and the blocking component in the release position, and

FIG. 10b shows a perspective view of a portion of the air flap device from FIG. 1 with a view of another aspect of the sensor arrangement from FIG. 10a and the blocking component in the release position.

### DESCRIPTION OF PREFERRED EMBODIMENTS

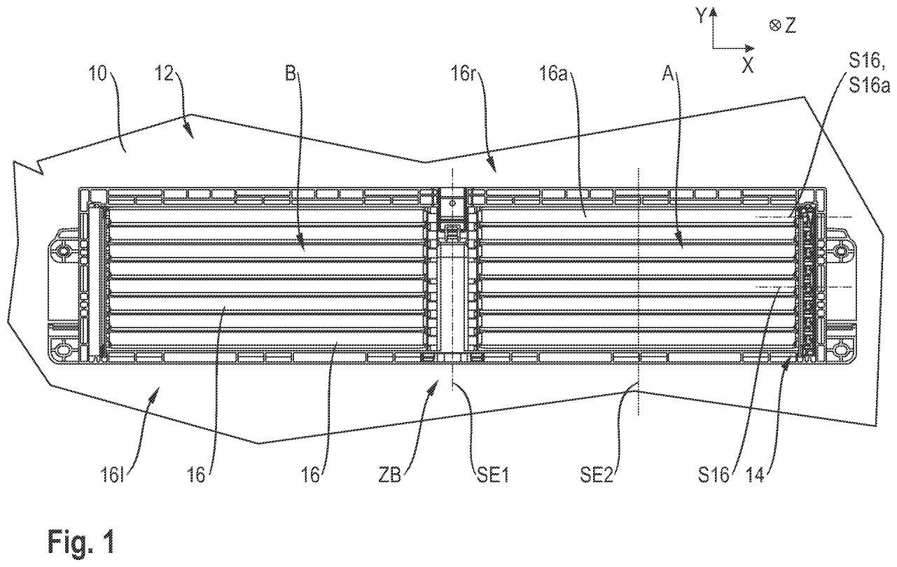

Referring now to the drawings wherein the showings are for the purpose of illustrating preferred and alternative embodiments of the invention only and not for the purpose of limiting the same, in FIG. 1, a section of a vehicle is generally designated by 10. This vehicle section 10 is viewed by an observer present in the engine compartment of the vehicle, i.e., from the inside with a viewing angle along the roll axis (direction Z) of the vehicle 10. The vehicle 10 carries an inventive embodiment of an air flap device 12 of the present invention. This device includes an air flap carrier 14 on which a plurality of air flaps 16, in the example more precisely sixteen air flaps 16, are received for pivoting about mutually parallel pivot axes S16. For reasons of clarity, only some of the air flaps are designated with the reference numeral 16 and only some of the pivot axes are designated with the reference numeral S16. The air flaps 16 include at least air flaps 16l, 16r, 16a, and 16b.

The air flap carrier 14 substantially extends in a plane spanned by the mutually perpendicular directions X and Y, wherein the directions X and Y are respectively perpendicular to the Z direction.

The air flap support 14 comprises two air passage openings A, B, which are arranged on the left and right of a central area ZB in FIG. 1. Each of the eight air flaps 16r protruding into the air passage opening A is preferably mirror-symmetrical to one of the eight air flaps 16l protruding into the air passage opening B with respect to a symmetry plane SE1 that runs perpendicular to the drawing plane of FIG. 1. Unless stated otherwise, the air flaps 16l, 16r protruding into one of the air passage openings A, B are of substantially the same design, such that in the following, where necessary, reference is only made to one air flap 16a of the air flaps 16r, which can be pivoted about the pivot axis S16a. The description of this air flap 16a, taking into account the above-mentioned symmetrical properties, can be applied to all air flaps 16l, 16r.

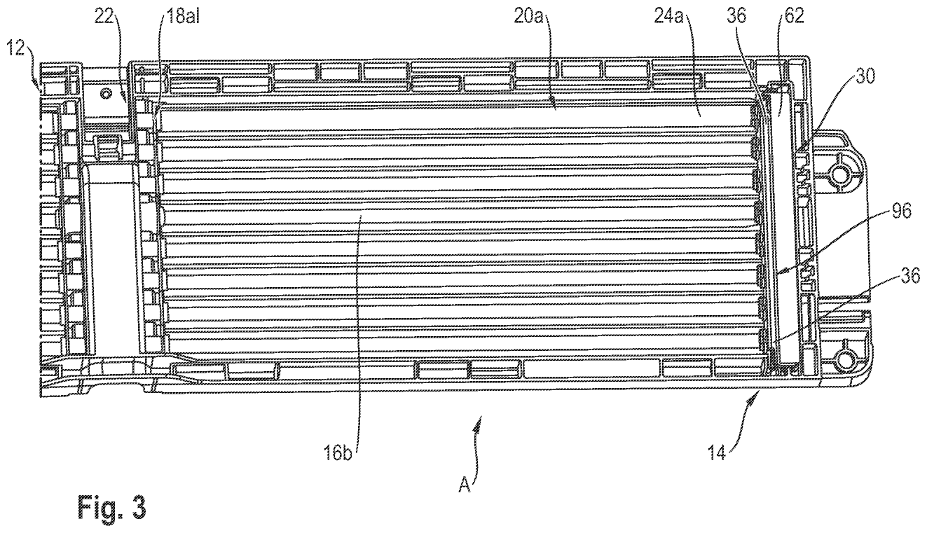

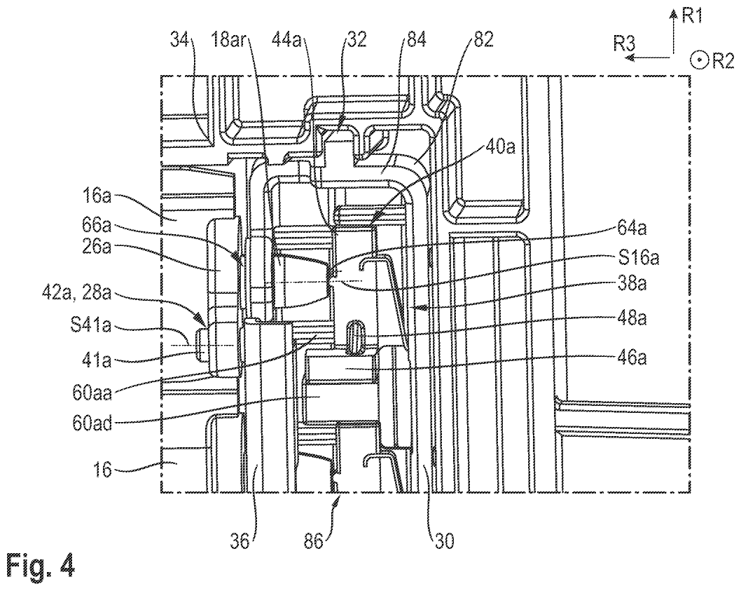

As can be seen in FIGS. 3 and 4, the air flap 16a comprises an air flap body 20a arranged centrally between two bearing pins 18al, 18ar, wherein the bearing pin 18al, which is received at a central receptacle 22 of the air flap device 12, is hidden by its receptacle in the figures. The air flap body 20a preferably comprises a flat air flap blade 24a and also an eccentric arm 26a with a through hole 28a on at least one of its ends, e.g. adjacent to the bearing pin 18ar. Preferably, the air flap 16a is mirror-symmetrical to a plane SE2 that runs perpendicular to the drawing plane of FIG. 1. The air flap 16a is received with the other of its two bearing pins 18ar on the air flap carrier 14 in its bearing insert 30, and is received on the air flap carrier 14 for pivoting about a pivot axis S16a when in operation by means of its two bearing pins 18al, 18ar. The bearing insert 30 is non-destructively detachable and reconnectable by means of a latching connection 32 coupled to an air flap support frame 34 of the air flap support 14. The air flap blade 24a shown here can be made particularly thin (about 1 mm thinner) than in the prior art DE 10 2018 131 448 A1, which means that, in the first operating position, the air flap 16a covers the air passage opening A less than in the prior art, and thus an improvement in the efficiency of the air flap device can be achieved.

On its bearing pin 18al adjacent to the central receptacle 22, the air flap 16a can comprise a second eccentric arm, not shown, which is designed substantially like the eccentric arm 26a.

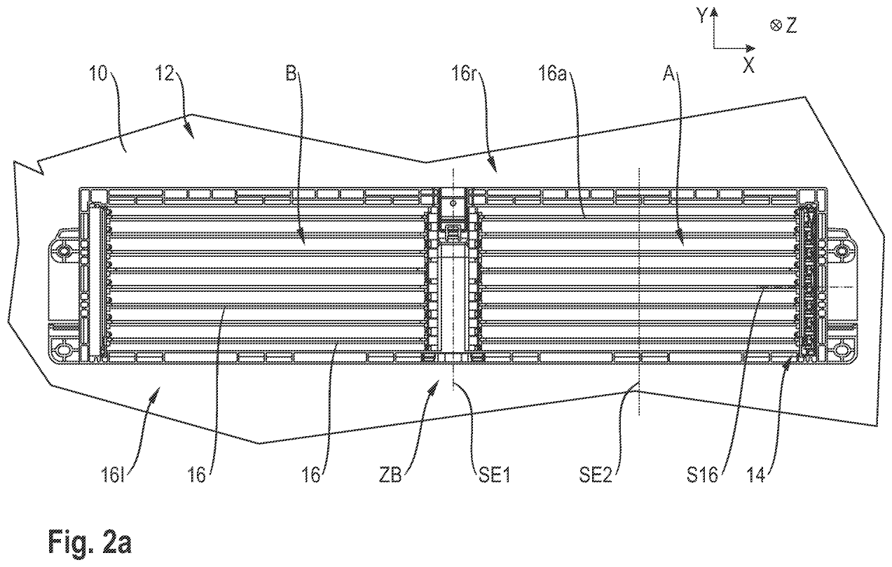

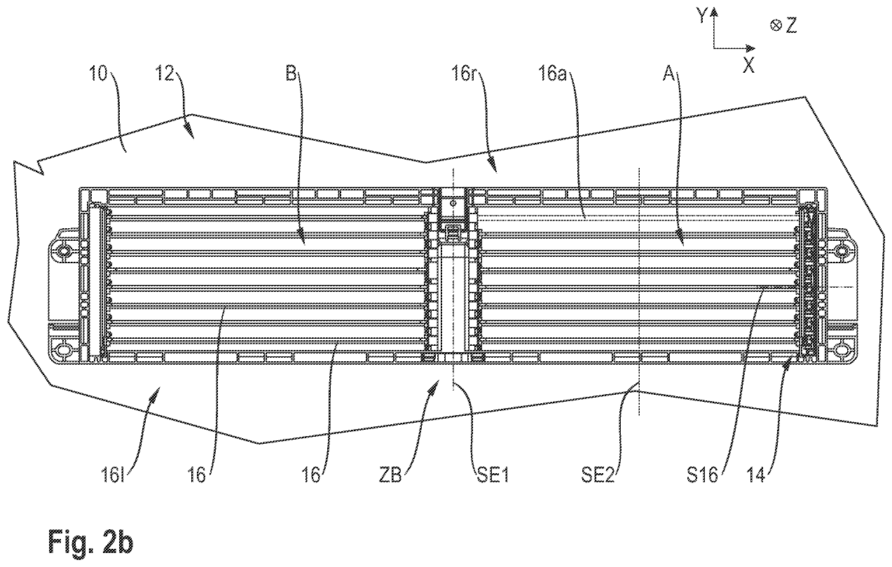

The air flap 16a can assume a second operating position, shown in FIGS. 1 and 3, in which it implements a substantially maximum coverage of the air passage opening A by the air flap 16a, and can further assume a first operating position shown in FIG. 2a, in which the air flap 16a is substantially rotated or pivoted by 90° with respect to its second operating position and in which the air flap 16a implements a substantially minimum coverage of the air passage opening A by the air flap 16a.

The other air flaps 16r covering the air passage opening A can also each assume a first operating position shown in FIG. 2a, in which the air flap blade of these air flaps runs substantially parallel to the air flap blade 24a of the air flap 16a in its first operating position, and also assume a second operating position, in which the air flap blade of these air flaps 16r extends substantially parallel to the air flap blade 24a of the air flap 16a in its second operating position. The coverage of the air passage opening A by these air flaps 16r is greater in their respective second operating positions than in their respective first operating positions. In FIG. 2b, the air flap 16a has been knocked out, while the remaining air flaps 16r of the air passage opening A are all in their first operating positions.

As shown in FIG. 4, a coupling device 36 couples to the eccentric arms of the air flaps 16r in such a way that each of the eccentric arms is rotatably coupled to the coupling device 36 by means of a coupling arrangement assigned to each eccentric arm, which, for example, comprises a shaft 41a arranged on the coupling device 36 and an axial bearing 42a holding the shaft 41 on the eccentric arm 26a (which for the sake of clarity is provided with reference numerals only on the air flap 16a), for example in the form of the through opening 28a. The axial bearing 42a forms a coupling device axial bearing. The shaft 41a is held in the axial bearing 42a so as to be pivotable about the coupling pivot axis S41a. As a result, the air flaps 16r are coupled for joint movement in such a way that they each assume their first operating position at the same time as well as their second operating position at the same time. When the coupling device 36 is in its first coupling position, the air flaps 16r each assume their first operative positions, and when the coupling device 36 is in its second coupling position, the air flaps 16r each assume their second operative positions. When the coupling device 36 transitions between its first coupling position and its second coupling position, the coupling device 36 moves along a coupling direction movement path KB. The coupling direction movement path KB can be defined by the movement path traversed by a point in the coupling device 36 when the coupling device 36 transitions from its first coupling position to its second coupling position. The coupling direction movement path KB preferably extends in a plane that runs parallel to the directions X and Z, and thus transversely, in particular perpendicularly, to the pivot axis S16a.

In some figures, an eccentric arm 26 of this air flap 16 is shown for an air flap 16 adjacent to the air flap 16a, which eccentric arm is coupled to the coupling device 36 by means of a shaft 41 arranged on the coupling device 36.

It is preferred that a second coupling device (not shown) is coupled to the second eccentric arms of the air flaps 16r by means of second coupling arrangements, wherein the second coupling arrangements correspond to those between the coupling device 36 and the eccentric arms. This additional coupling of the air flaps 16r by means of the second coupling device allows a driving force of a drive received in the central receptacle 22, which drives the air flap 16b directly (see FIG. 3), for example, to be applied particularly reliably due to the air flaps 16r due to the redundancy between the coupling device 36 and the second coupling device. If the drive torque of the drive is monitored, a blockage of the coupling device 36 when a threshold of the drive torque is exceeded can be detected more reliably due to the stiffening caused by the second coupling device. The stiffening by the second coupling device also improves the behavior of the air flap device 12 when the blocking component 40a described below is in its blocking position (blocking behavior), since there are fewer twists in the air flap device 12 due to which elements could tilt.

Each of the air flaps 16r is configured as a sensing air flap with an associated blocking arrangement, wherein the blocking arrangement comprises at least one separate blocking component. The following description of the air flap 16a configured as a sensing air flap, its interaction with the blocking arrangement 38a assigned thereto, which comprises at least one blocking component 40a, applies to all sensing air flaps and their blocking arrangements unless otherwise stated in the description. The pivot axis S16a. forms a sensing air flap pivot axis.

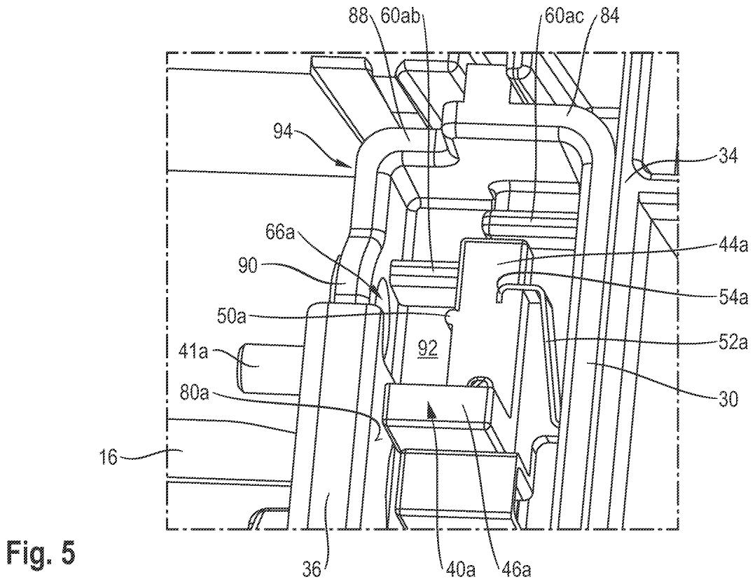

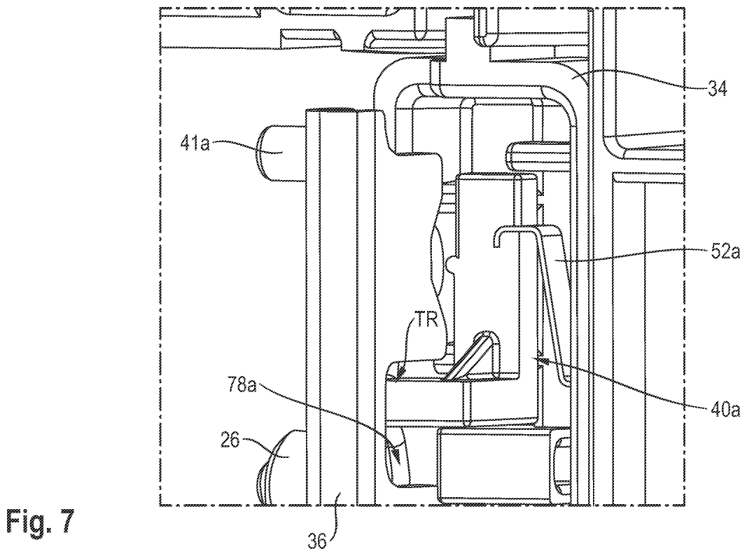

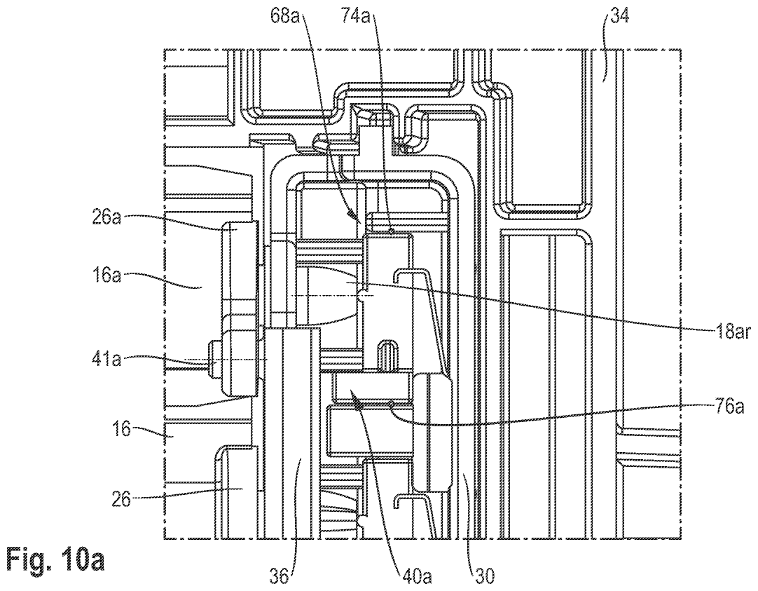

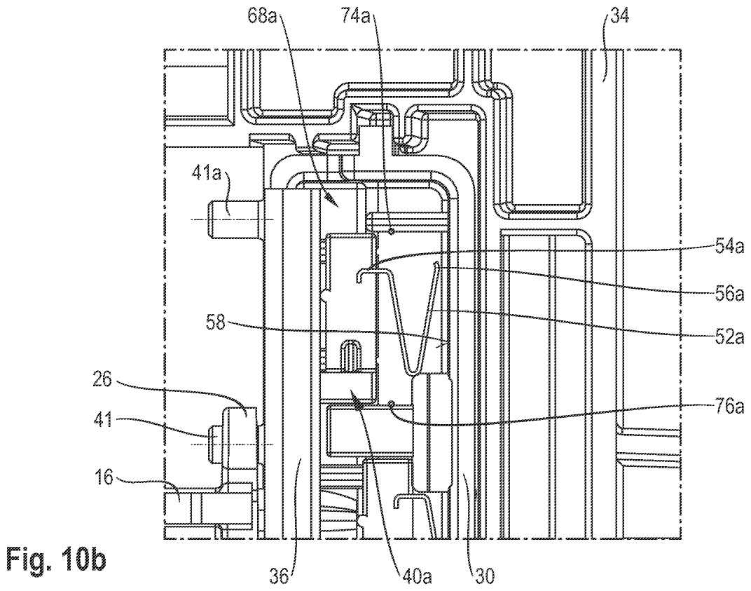

The bearing insert 30 is provided with a receptacle in the form of an axial bearing 66a, configured as a through opening, in which the bearing pin 18ar is mounted pivotably about the pivot axis S16a, such that the bearing insert 30 operatively receives the air flap 16a for pivoting. The axial bearing 66a forms a pivot bearing and a bearing insert axial bearing. The blocking component 40a is substantially L-shaped with a base element 44a that corresponds to the long L arm and extends in direction R1 and with a locking element 46a that extends in direction R2 and corresponds to the short L arm, which extends at least in sections over the base element 44a protrudes in direction R3, the directions R1, R2 and R3 being perpendicular to each other. The blocking component 40a is preferably formed in one piece by injection molding, wherein the base element 44a and the locking element 46a are formed with a preferably triangular reinforcing strut 48a extending in a plane parallel to the directions R1 and R2 to increase the dimensional stability of the blocking component 40a, the extension direction R3 of which strut is smaller than the extension direction of the base element 44a and the locking element 46a in the direction R3, respectively. Preferably, the direction R1 is substantially parallel or anti-parallel to the direction X, the direction R2 is substantially parallel or anti-parallel to the direction Y, and the direction R3 is substantially parallel or anti-parallel to the direction Z when the bearing insert 30 is operatively connected to air flap support frames 34 using the latching connection 32. A rib 50a is provided on the base element 44a, forming a holding abutment projection and extending parallel to the direction R2 over the entire thickness of the base element 44a in the direction R2, see FIG. 5. A bending spring 52a is cast into the base element 44a on its end 54a attached to the blocking component, wherein h the free end 56a of the bending spring 52a is supported on an inner wall 58 of the bearing insert 30 for relative movement thereto, see FIG. 10b. The blocking component 40a is guided in the bearing insert 30 by a plurality of ribs 60aa to 60ad extending in the direction R3 and a bearing insert cover 62 substantially along a direction parallel to the direction R3, such that it can be moved between the release position shown in FIG. 4 and the blocking position shown in FIG. 7. During the movement of the blocking component 40a between the blocking position or the release position, the blocking component 40a, in particular the locking element 46a, moves along a locking path AP running substantially parallel to the direction R3, and thus substantially parallel to the pivot axis S16a. The ribs 60aa to 60ad and the bearing insert cover 62 each individually or together form a guide arrangement for the blocking component 40a. When the blocking component 40a is in its release position, the movements of the blocking component 40a and the coupling device 36 are independent of one another.

The rib 50a rests against an end face 64a of the bearing pin 18ar, which end face forms a mating retaining contact surface and which forms a plain bearing together with the rib 50a. The bearing pin 18ar is formed in one piece with the remainder of the air flap 16a and is in particular coupled thereto. The bearing pin 18ar forms a retaining formation which holds the blocking component 40a in the release position when the air flap 16a is received on the air flap carrier for operative motion, here in the bearing insert 30. The bearing pin 18ar shown here can be formed without using a GID process.

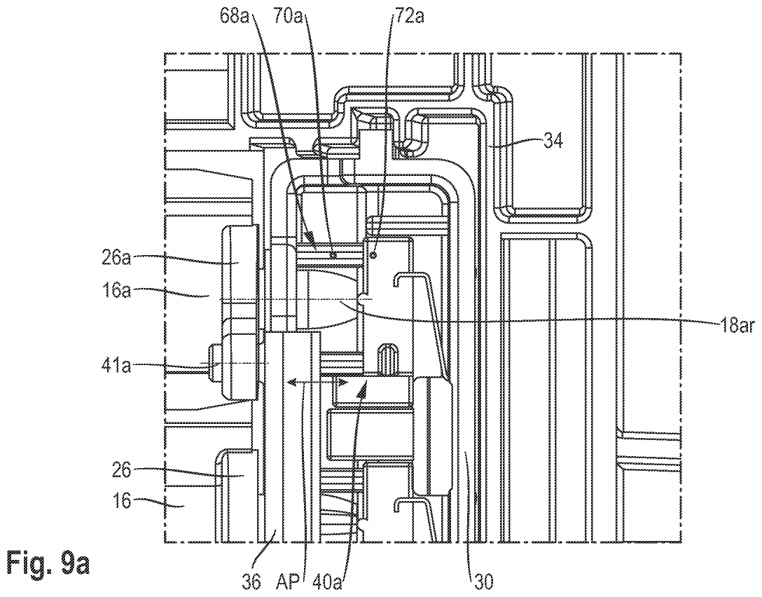

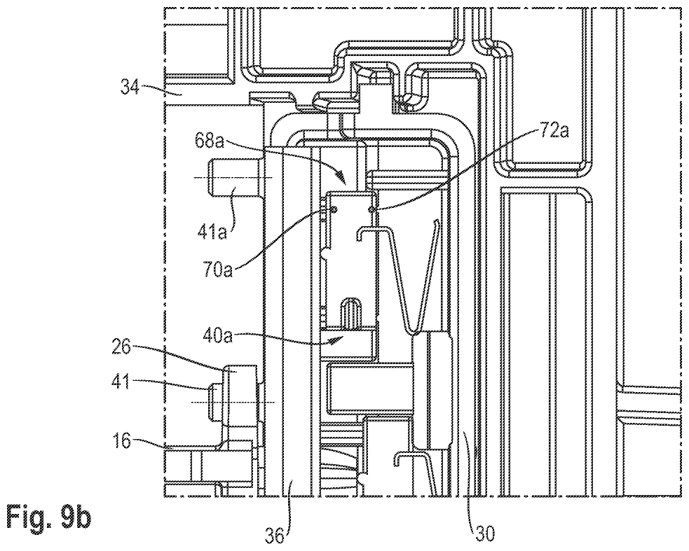

The air flap device 12 can comprise a sensor arrangement for each sensing air flap shown in FIGS. 9a to 10b, wherein only the sensor arrangement 68a for the air flap 16a configured as sensing flaps is described and this description correspondingly applies to each sensor arrangement of the air flap device 12, since the sensor arrangements are preferably of substantially the same configuration. The sensor arrangement 68a is configured to detect a transition of the blocking component 40a between the release position and the blocking position. For this purpose, in a first embodiment of FIGS. 9a and 9b comprise an electrical signal path which has a first electrical signal path arm ending at a first contact 70a, for example in the form of an electrically conductive line, e.g. a wire or a conductor track formed from electrically conductive plastic, and a second electrical signal path arm terminating at a second contact 72a, for example in the form of an electrically conductive line, e.g. B. a wire or a conductor track formed from electrically conductive plastic. In the release position of the blocking component 40a, there is no electrical contact between the first contact 70a and the second contact 72a and no signals can accordingly be transmitted from the first electrical signal path arm to the second electrical signal path arm, such that the signal path cannot be passed by signals. If the blocking component 40a is in its blocking position, an electrically conductive portion of the blocking component 40a, for example an electrically conductive line, such as a wire, a sliding contact in the form of a metal strip, or a conductor track formed from electrically conductive plastic, connects the first contact 70a with the second contact 72a, whereby a circuit comprising the signal path is closed. Due to this effect of the blocking component 40a on the signal path, electrical signals, for example currents or/and electricity and/or voltage pulses, then pass through both signal path arms of the signal path, whereby the transition of the blocking component 40a between the release position and the blocking position can be detected. In a particularly simple configuration of the sensor arrangement, the entire blocking component 40a is made of conductive plastic.

Alternatively or in addition, the sensor arrangement 68a comprises an optical signal path shown in FIGS. 10a and 10b, wherein at least one air propagation section of this signal path between a light emitter 74a and a light sensor 76a is configured such that light operatively propagates through air along this air propagation section, in this case the straight line between light emitter 74a and a light sensor 76a. As shown in FIG. 10a, the blocking component 40a interrupts the air propagation section in its release position, such that no optical signal, for example in the form of a continuous and/or modulated light, can pass through the optical signal path due to this action of the blocking member 40a on the signal path. If the blocking component 40a is in the blocking position, see FIG. 10b, it releases the air propagation section and optical signals can pass through the optical signal path. It should be noted that, for example when using light-conducting fibers, the light source, such as a light-emitting diode, of the light emitter 74a and the light-sensing element, such as a photodiode, of the light sensor 76a can also be located remotely from the air propagation section, for example outside of the bearing insert 30. If the sensor arrangement 68a alternatively comprises the optical signal path, no section of the blocking component 40a has to be configured to be electrically conductive. The passing or/and failure to pass of the signals discussed above through the respective signal path can be detected using means known to those skilled in the art, and this information can be transmitted to an on-board diagnostic system of the motor vehicle.

Alternatively, the blocking component 40a can be light conducting, such that it conducts light between the light emitter 74a and the light sensor 76a in its release position shown in FIG. 10a, but modulates the light, for example by means of a first color filter. The light sensor 76a is then configured to be sensitive to the modulation of the light by the blocking component 40a. If, for example, the light emitter 74a emits white light and the light sensor 76a is color-sensitive, for example represented by a second color filter, such that a combination of the first and second color filters substantially does not let any light through, then a transition of the blocking component 40a between its release position and its blocking position can also be detected when the blocking component 40a in its release position allows the light between the light emitter 74a and the light sensor 76a to pass in a modulated manner.

The function of the air flap assembly 12 is described below if, in the event of a malfunction, the air flap 16a is no longer held properly on the air flap carrier 14 because its bearing pin 18ar as part of the air flap 16a is removed from the axial bearing 66a, for example due to the air flap 16a being knocked out of the air flap assembly 12 due to an accident or falling rocks.

First, the case shown in FIG. 7 will be described, in which the coupling device 36 is in its first coupling position and the air flaps 16r assume their first operating positions, respectively. In the coupling device 36, a recess is assigned to each blocking component of each sensing air flap, wherein only the recess 78a assigned to the blocking component 40a and its functionality is described. This description also applies to each recess of the coupling device 36 assigned to the blocking component and their functionality.

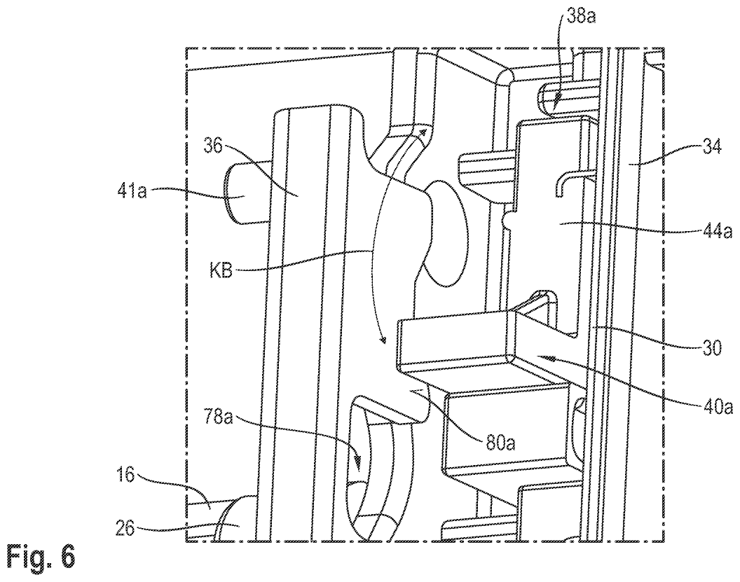

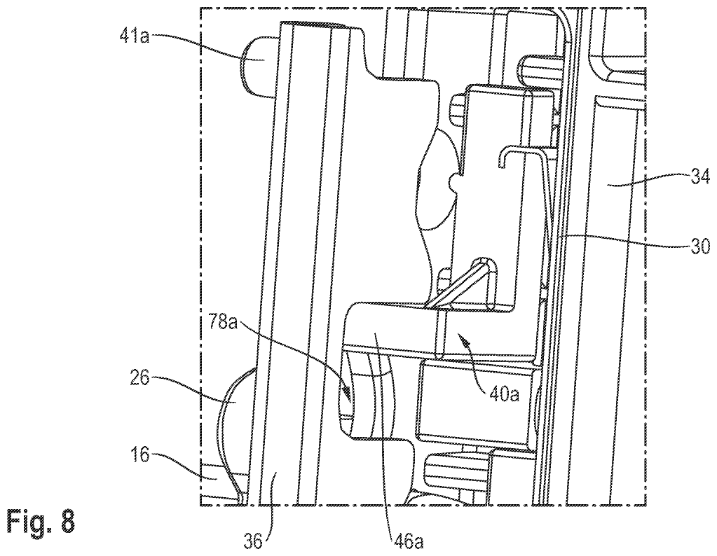

The recess 78a is formed in the coupling device 36 in such a way that in the first coupling position of the coupling device 36 the locking path AP of the blocking component 40a runs through the recess 78a. The locking path AP can be defined by the movement path passed by a point located in the blocking component 40a when the blocking component 40a transitions between its release position and its blocking position. The recess 78a, which is U-shaped in this embodiment, is dimensioned such that, when the coupling device 36 is arranged in its first coupling position, it allows the blocking component 40a to transition into its blocking position and thus does not impede it. The space section TRa occupied by the section of the blocking component 40a that is in the blocking position and located in the recess 78a is an example of a transverse space section. The bending spring 52a forming a pretensioning arrangement pretensions the blocking component 40a in the direction R3 into its blocking position. If the bearing pin 18ar is not in its operational receptacle on the air flap carrier 14, for example if it no longer protrudes through the axial bearing 66a into the interior of the bearing insert 30, the bearing pin 18ar no longer holds the blocking component 40a in its release position and the bending spring 52a drives this blocking component 40a into its blocking position, in which it engages in the recess 78a with the locking element 46a. Preferably, the recess 78a is dimensioned such that, when the blocking component 40a has assumed its blocking position, the coupling device 36 can move in sections along the coupling direction movement path KB (see FIG. 6), but reaching the second coupling position is prevented by the then occurring abutment of the locking member 46a on an inner periphery of the recess 78a, as shown in FIG. 8. This system blocks the movement of the coupling device 36 into the second coupling position, which represents a mechanical detection of a malfunction of the air flap device: On the one hand, the air passage opening A, which is constantly not closed, can be visually perceived by a user. On the other hand, depending on the design of the drive, if the drive received in the central receptacle 22 attempts to drive the air flap 16b to move the air flaps 16r into their second operating positions (which would be accompanied by the assumption of the second coupling position by the coupling device 36), exceeding a drive torque, for example by detecting a drive current of this drive, can be sensed by an on-board diagnosis of the vehicle 10, because the movement of the coupling device 36 into the second coupling position is blocked due to the engagement of the blocking component 40a in the recess 78a. The malfunction described here can also be detected by the sensor arrangement 68a if a transition of the blocking component 40a from its release position into its blocking position is detected by the sensor arrangement 68a. Because the movement of the coupling device 36 into its second coupling position is blocked, a transition of the air flaps 16r into their second operating position (closed position) is prevented, such that a sufficient supply of air through the air passage opening A for cooling functional assemblies in the engine compartment is enabled. The permitted partial movement of the coupling device 36 along the coupling direction movement path KB when the blocking component 40a is in its blocking position preferably corresponds to a pivoting of each of the air flaps 16r by less than 15°, preferably by less than 10°, or equal to 10°. The blocking of the movement of the coupling device 36 in a position of the remaining air flaps 16r that differs by 10° from the first operating position in the direction of their second operating position is shown in FIG. 8. The coupling direction movement path KB runs transversely, in particular substantially perpendicularly, to the locking path AP and to the pivot axis S16a. The locking path AP runs substantially parallel to the pivot axis S16a.

If a malfunction of the air flap device 12 is detected by or during the transition of the blocking component 40a to its blocking position, the air flaps 16r can no longer reach their second operating position and the air passage opening A can no longer be closed. This property of the air flap device 12 can be taken into account when evaluating the diagnostic signals of the sensor arrangement 68a.

If the coupling device 36 is in its second coupling position at the time when the bearing pin 18ar no longer holds the blocking component 40a in its release position, see FIG. 5, the bending spring 52a drives the blocking component 40a in the direction of its blocking position until the locking element 46a abuts against a section of the coupling device, for example a flat surface 80a assigned to the blocking component 40a, which surface crosses the locking path AP. The wall of the coupling device 36 which is arranged in the second coupling position and which carries the planar surface 80a occupies the space section TRa at least in sections and prevents the blocking component 40a from reaching its blocking position.

If there is an increased need for an air supply through the air passage opening A for cooling functional assemblies in the engine compartment, the coupling device 36 can also be transferred from its second coupling position to its first coupling position, as shown in FIG. 6, even if the bearing pin 18ar no longer holds the blocking component 40a in its release position.

As soon as the transverse space section is released by the coupling device 36, i.e., as soon as the recess 78a encompasses the transverse space section, the bending spring 52a drives the blocking component 40a into the blocking position of the blocking component 40a. Then, as described above, movement of the coupling device 36 back into its second coupling position is prevented.

The transverse space section is preferably released from the coupling device 36 when, during the transition of the coupling device 36 from its second coupling position to its first coupling position, the remaining air flaps 16r reach an angular position on their way from their second operating position to their first operating position which is 15° to 10° before its first operating position.

The sensor arrangement 68a is preferably configured to sense this beginning of the transition of the blocking component 40a from its release position to its blocking position, as early as in the position of blocking component 40a in which the locking element 46a is in contact with the flat surface 80a, by appropriately arranging first and second contacts 70a, 72a or the light emitter 74a and the light sensor 76a.

The coupling pivot axis S41a and the air flap pivot axis S16a run parallel to one another, such that the bearing insert 30 together with the coupling device 36 guided in the bearing insert 30 can be pushed onto the air flaps 16r in a movement running substantially parallel to the coupling pivot axis S41a. Thereafter, the bearing insert 30 can be connected to the air flap support frame 34 using the latching connection 32.

The bearing insert 30 comprises a bearing insert body 82 shown in FIGS. 4 to 8 shown having a main opening 86 delimited in sections substantially parallel to the drawing plane by the edge 84. The edge 88 of the wall 90 facing the air passage opening A of the bearing insert body 82 is set off from the edge 84 towards a bottom 92, such that the bearing insert body 82 has a side opening (or recess) 94 which is not delimited by the bearing insert body 82 in a direction away from the bottom 92. The bearing insert cover 62 is designed in such a way that when it is operationally connected to the bearing insert body 82, for example using a snap-in connection or an adhesive connection, the bearing insert cover 62 largely closes the main opening 86, but closes a region of the main opening 86 towards the wall 90, for example in the form of a gaps, leaves free. At least a section of the coupling device movement path KB runs through the opening 96 that remains in this way. In particular, the coupling device 36 has a substantially flat configuration running in the plane defined by the directions X and Z, such that, when the coupling device 36 is operatively received in the bearing insert 30, the side opening 94 is at least in sections covered by this coupling device 36. Preferably, the side opening is 94 at least in part, preferably more than 50%, covered by the coupling device 36.

The coupling device 36 preferably slides on the wall 90 which then forms a guide arrangement for the coupling device 36.

The blocking arrangement 38a preferably comprises the blocking component 40a, the bending spring 52a, and the recess 78a.

If the air flap 16a is broken, the bending spring 52a pushes the bearing pin 18ar out of the axial bearing 66a by means of the blocking component 40a or/and supports this movement. If, with a broken air flap 16a, the bearing pin 18ar should be in the axial bearing 66a or/and the shaft 41a should be jammed in the axial bearing 42a, the bending spring 52a pretensions the bearing pin 18ar in the direction R3 by means of the blocking component 40a. The inventor has found that these jammings are usually released during a few rotary or pivoting movements of the remaining undamaged air flaps 16 of the air passage opening A, for example when transferring these remaining undamaged air flaps between their first and second operating positions, since the eccentric arm 26a is in these cases usually further coupled to the coupling device 36 by means of the shaft 41a. If these jammings are released, the bearing pin 18ar moves in direction R3, for example completely out of the axial bearing 66a, and the bearing pin 18ar then no longer holds the blocking component 40a in its release position.

The inventor has found that 3 to 5 cycles of a movement from one of the operating positions of these remaining undamaged air flaps to the other operating position and back to one of the operating positions are usually sufficient to release these jams. Rotating or pivoting movements of these remaining undamaged air flaps often occur during operation of the air flap assembly.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. An air flap device, comprising:
an air flap carrier with an air passage opening through which air can flow,
a plurality of air flaps,
wherein each of these air flaps protrudes at least into the air passage opening and is received on the air flap carrier for operative movement,
wherein each of these air flaps is movable between a first and a second operating position assigned thereto,
wherein, for each of these air flaps, a covering of the air passage opening by this air flap is respectively greater in the second operating position assigned thereto than in the first operating position assigned thereto,
wherein the plurality of air flaps comprises at least one sensing air flap,
a coupling device, wherein the coupling device couples the at least one sensing air flap to at least one other air flap of the plurality of air flaps for joint movement, and
a blocking component assigned to the at least one sensing air flap,
wherein the blocking component is displaceable between a release position in which it permits movement of the coupling device and a blocking position in which it blocks movement of the coupling device,
wherein when the blocking component is in its release position, the coupling device is movable independently of the blocking component.

17. The air flap device according to claim 16, wherein the air flap device comprises a retaining formation coupled to the sensing air flap, wherein, when the sensing air flap is received on the air flap support for operative movement, the retaining formation holds the blocking component in its release position.

18. The air flap device according to claim 17, wherein the sensing air flap is formed in one piece with the retaining formation assigned thereto.

19. The air flap device according to claim 18, wherein the retaining formation forms at least part of a bearing pin of the sensing air flap.

20. The air flap device according to claim 16, wherein the sensing air flap is pivotably held on the air flap carrier in a receptacle arranged on the air flap carrier, such that it can pivot about a sensing air flap pivot axis,
wherein the blocking member is displaceable in a direction substantially parallel to the sensing air flap pivot axis between its release position and its blocking position.

21. The air flap device according to claim 16, wherein during the transition of the other air flap between its first operating position and its second operating position or/and during the transition of the sensing air flap between its first operating position and its second operative position, the coupling device passes along a coupling device movement path which is substantially transverse to a sensing air flap pivot axis of the sensing air flap.

22. The air flap device according to claim 21, wherein the sensing air flap pivots about the sensing air flap pivot axis in transition between its first operative position and its second operative position.

23. The air flap device according to claim 16, wherein the coupling device assumes a first coupling position when the other air flap is in its first operating position, wherein the coupling device assumes a second coupling position when the other air flap is in its second operating position, wherein the coupling device arranged in the first coupling position allows movement of the blocking component into its blocking position, and wherein the coupling device arranged in the second coupling position prevents movement of the blocking component into its blocking position.

24. The air flap device according to claim 23, wherein, during the transition of the blocking component from its release position to its blocking position, at least one section of the blocking component passes through a traverse space section which, when the blocking component is in its release position, is not occupied by the blocking component,
wherein the coupling device arranged in the first coupling position does not occupy the traverse space section, as a result of which movement of the blocking component into its blocking position is allowed,
wherein a section of the coupling device arranged in the second coupling position occupies the traverse space section, as a result of which movement of the blocking component into its blocking position is prevented.

25. The air flap device according to claim 24, wherein the air flap device comprises a retaining formation coupled to the sensing air flap, wherein, when the sensing air flap is received on the air flap support for operative movement, the retaining formation holds the blocking component in its release position and wherein, when the retaining formation no longer holds the blocking component in its release position and the coupling device is arranged in its second coupling position, the blocking component abuts against a section of the coupling device due to the action of a force from a pretensioning arrangement of the air flap device.

26. The air flap device according to claim 16, wherein the air flap device further comprises a sensor arrangement which is designed to sense a transition of the blocking component between its release position and its blocking position.

27. The air flap device according to claim 26, wherein the sensor arrangement comprises a signal path and is configured to detect signals passing through the signal path,
and wherein the blocking component acts on the signal path in such a way that, when the blocking component is arranged in one of its release position and its blocking position, the signals can pass through the signal path, and when the blocking component is arranged in the other of its release position and its blocking position, the signals cannot pass through the signal.

28. The air flap device according to claim 27, wherein the signals are electrical signals or/and are optical signals.

29. The air flap device according to claim 16, wherein the air flap carrier comprises an air flap carrier frame and a bearing insert which is connected to the air flap carrier frame,
wherein each of the air flaps of said plurality of air flaps is received in said bearing insert for operative movement, and
wherein the bearing insert has a guide arrangement for the blocking component or/and a guide arrangement for the coupling device.

30. The air flap device according to claim 29, wherein, during the transition of the other air flap between its first operating position and its second operating position or/and during the transition of the sensing air flap between its first operating position and its second operating position, the coupling device passes along a coupling device movement path,
wherein the bearing insert comprises a bearing insert body formed with a main opening and a bearing insert cover operatively attachable to the bearing insert body, wherein the bearing insert cover operatively attached to the bearing insert body closes the main opening in sections and leaves an opening free between the bearing insert cover and the bearing insert body, through which opening at least one section of the coupling device movement path passes.

31. The air flap device according to claim 30, wherein each of the air flaps of the plurality of air flaps is held on a bearing insert axial bearing for pivoting about a respective air flap pivot axis on the bearing insert,
wherein each of the air flaps of the plurality of air flaps is held on a coupling device axial bearing for pivoting about a respective coupling pivot axis on the coupling device,
wherein each of the air flap pivot axes is oriented substantially parallel to each other air flap pivot axis or/and wherein each of the coupling pivot axes is oriented substantially parallel to each other coupling pivot axis or/and wherein each of the air flap pivot axes is oriented substantially parallel to each coupling pivot axis.

32. The air flap device according to claim 29, wherein each of the air flaps of the plurality of air flaps is held on a bearing insert axial bearing for pivoting about a respective air flap pivot axis on the bearing insert,
wherein each of the air flaps of the plurality of air flaps is held on a coupling device axial bearing for pivoting about a respective coupling pivot axis on the coupling device,
wherein each of the air flap pivot axes is oriented substantially parallel to each other air flap pivot axis or/and wherein each of the coupling pivot axes is oriented substantially parallel to each other coupling pivot axis or/and wherein each of the air flap pivot axes is oriented substantially parallel to each coupling pivot axis.

33. The air flap device according to claim 16, wherein each air flap of the plurality of air flaps is a sensing air flap.

34. The air flap device according to claim 16, wherein each air flap of the plurality of air flaps is a sensing air flap, which is assigned to a separate associated blocking component.
